(19) United States
(12) Patent Application Publication
(10) Pub. No.: US 2013/0127409 A1
(43) Pub. Date: May 23, 2013

(54) POWER TRANSMISSION SYSTEM, VEHICLE AND POWER SUPPLY FACILITY

(71) Applicant: Shinji ICHIKAWA, Toyota-shi (JP)

(72) Inventor: Shinji ICHIKAWA, Toyota-shi (JP)

(21) Appl. No.: 13/673,652

(22) Filed: Nov. 9, 2012

(30) Foreign Application Priority Data
Nov. 18, 2011 (JP) 2011-252821

(51) Int. Cl. H02J 7/00

(52) U.S. Cl. CPC H02J 7/0047
USPC 320/108

(57) ABSTRACT

Power is transmitted from a power supply facility to a vehicle in a contact-less manner. A control device detects a distance between a power transmission unit of the power supply facility and a power receiving unit of the vehicle. A display unit displays a graphic in a display pattern which varies in accordance with the distance detected by the detection unit.

### INCORPORATION BY REFERENCE

The disclosure of Japanese Patent Application No. 2011-252821 filed on Nov. 18, 2011 including the specification, drawings and abstract is incorporated herein by reference in its entirety.

### BACKGROUND OF THE INVENTION

1. Field of the Invention

The invention relates to a power transmission system, a vehicle, and a power supply facility. In particular, the invention relates to a power transmission system in which power is transmitted from a power supply facility to a vehicle in a contact-less manner, relates to a vehicle that receives power from a power supply facility in a contact-less manner, and relates to a power supply facility that supplies power to a vehicle in a contact-less manner.

2. Description of the Related Art

Contact-less wireless power transmission that does not use power source cords or power transmission cables has received attention in recent years. Wireless power transmission has been proposed for use in electric automobiles, hybrid vehicles and the like that allow charging of an on-vehicle storage device by a power source that is external to the vehicle (hereafter also referred to as “external power source”).

Japanese Patent Application Publication No. 2010-172185 (JP 2010-172185 A) discloses a power reception guidance device for a vehicle in which a storage device installed therein can be charged from an external power source in a contact-less manner, the power reception guidance device performing guidance relating to contactless charging from a power supply facility that is disposed in a parking area, to a power receiving unit that is disposed in the vehicle.

The power reception guidance device is provided with a power reception efficiency specifying unit, a determination unit, a speaker and a display. The power reception efficiency specifying unit specifies a power reception efficiency of a power receiving unit at a parking position of the vehicle in a parking area. The determination unit determines whether the parking position must be modified or not, on the basis of the power reception efficiency as specified by the power reception efficiency specifying unit. Information based on the determination result by the determination unit are outputted by the speaker and the display. A camera is disposed in the vehicle. A mark for indicating the location of the buried power supply device is provided in the parking area. The camera is disposed, pointing downward of the vehicle, so as to be capable of capturing that mark. Image data acquired by the camera is outputted to the power reception guidance device. A positional relationship between the power supply device and the power receiving unit is specified on the basis of the image data. The power supply device mark that denotes the position of the power supply device and a power receiving unit mark that denotes the position of the power receiving unit in the vehicle are displayed on the display.

In this power reception guidance device, the power receiving unit can be positioned at an efficiency-increasing position, at which power reception efficiency can be increased, through displacement of the vehicle in such a manner that the power supply device mark and the power receiving unit mark match each other (JP 2010-172185 A).

The power reception guidance device disclosed in JP 2010-172185 A performs guidance display so as to position the power receiving unit at a better-efficiency position. The power reception guidance device is thus advantageous in that it allows increasing power reception efficiency. However, although a relative position between the power supply device mark and the power receiving unit mark is displayed in the power reception guidance device display, the user cannot ascertain immediately whether the current position is a position appropriate for charging or not. Installing a camera, or a sensor or the like instead of the camera, in order to specify the positional relationship between the power supply device and the power receiving unit, would drive up costs in proportion to the installed camera or the installed sensor or the like instead of the camera.

### SUMMARY OF THE INVENTION

The invention provides a power transmission system, a vehicle and a power supply facility that enable a user to easily know visually the distance between a power transmission unit of a power supply facility and a power receiving unit of a vehicle.

A power transmission system of a first aspect of the invention is a power transmission system in which power is transmitted from a power supply facility to a vehicle in a contactless manner, the power transmission system having: a detection unit that detects a distance between a power transmission unit of the power supply facility and a power receiving unit of the vehicle; and a display unit that displays a graphic in a display pattern that varies in accordance with the distance detected by the detection unit.

A vehicle of a second aspect of the invention is a vehicle that receives power from a power supply facility in a contactless manner, the vehicle having: a power receiving unit that receives power from a power transmission unit of the power supply facility in a contact-less manner; a detection unit that detects a distance between the power receiving unit and the power transmission unit; and a display unit that displays a graphic in a display pattern that varies in accordance with the distance detected by the detection unit.

A power supply facility of a third aspect of the invention is a power supply facility that supplies power to a vehicle in a contact-less manner, the power supply facility having: a power transmission unit that transmits power to a power receiving unit of the vehicle in a contact-less manner; a detection unit that detects a distance between the power transmission unit and the power receiving unit; and a display unit that displays a graphic in a display pattern that varies in accordance with the distance detected by the detection unit.

In the above-mentioned aspects of the invention, power is transmitted from the power supply facility to the vehicle in a contactless manner. The distance between the power transmission unit of the power supply facility and the power receiving unit of the vehicle is detected, and the display unit displays the graphic in the display pattern that varies in accordance with the distance detected by the detection unit. As a result, the user of the vehicle can easily know visually the distance between the power transmission unit of the power supply facility and the power receiving unit of the vehicle, because the display pattern of graphic that is displayed on the display unit varies in accordance with the distance. Therefore, the aspect of the invention allows the user to easily know visually the distance between the power transmission unit of the power supply facility and the power receiving unit of the vehicle.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an overall configuration diagram of a vehicle power supply system in Embodiment 1 of the invention;

FIG. 2 is a functional block diagram for explaining in detail the configuration of a vehicle and a power supply facility illustrated in FIG. 1;

FIG. 3 is a first diagram illustrating a display pattern of the graphic displayed on the display unit illustrated in FIG. 2;

FIG. 4 is a second diagram illustrating a display pattern of the graphic displayed on the display unit illustrated in FIG. 2;

FIG. 5 is a third diagram illustrating a display pattern of the graphic displayed on the display unit illustrated in FIG. 2;

FIG. 6 is a detailed configuration diagram of a control device illustrated in FIG. 2;

FIG. 7 is a diagram illustrating a relationship between primary-side voltage and distance between a power transmission unit and a power receiving unit;

FIG. 8 is a diagram illustrating a relationship between secondary-side voltage and distance between a power transmission unit and a power receiving unit;

FIG. 9 is an equivalent circuit diagram at a time of power transmission from a power supply facility to a vehicle;

FIG. 10 is a diagram illustrating a simulation model of a power transmission system;

FIG. 11 is a diagram illustrating a relationship between power transmission efficiency and offset in the natural frequencies of a power transmission unit and a power receiving unit;

FIG. 12 is a graph illustrating the relationship between power transmission efficiency, upon changes in an air gap and the frequency of current supplied to a power transmission unit, in a state where a natural frequency is fixed;

FIG. 13 is a diagram illustrating a relationship between the distance from a current source (magnetic current source) and the intensity of an electromagnetic field;

FIG. 14 is a diagram illustrating a display pattern of the graphic displayed on a display unit in a variation;

FIG. 15 is a functional block diagram for explaining the configuration of a vehicle in Embodiment 2; and

FIG. 16 is a functional block diagram for explaining the configuration of a vehicle and a power supply facility in Embodiment 3.

### DETAILED DESCRIPTION OF EMBODIMENTS

Embodiments of the invention are explained in detail below with reference to accompanying drawings. In the figures, identical or equivalent portions are denoted with identical reference numerals, and an explanation thereof will not be repeated.

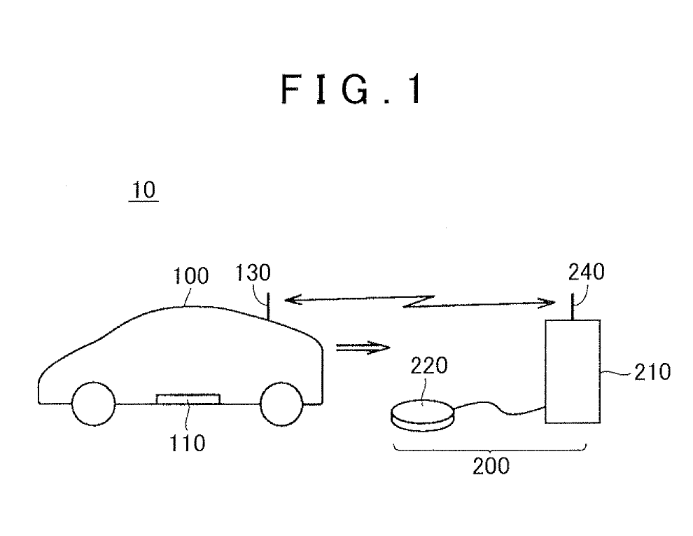

FIG. 1 is an overall configuration diagram of a vehicle power supply system in Embodiment 1 of the invention. With reference to FIG. 1, a vehicle power supply system 10 is provided with a vehicle 100 and a power supply facility 200. The vehicle 100 has a power receiving unit 110 and a communication unit 130.

The power receiving unit 110 is disposed at the bottom face of the vehicle body. The power receiving unit 110 receives, in a contactless manner, through of an electromagnetic field, high-frequency alternating current (AC) power that is outputted by a power transmission unit 220 (described below) of the power supply facility 200. The configuration of the power receiving unit 110 will be explained further on together with the configuration of the power transmission unit 220 and power transmission from the power transmission unit 220 to the power receiving unit 110. The communication unit 130 is a communication interface for communication of the vehicle 100 with the power supply facility 200.

The power supply facility 200 has a power source unit 210, the power transmission unit 220 and a communication unit 240. The power source unit 210 generates AC power having a predetermined frequency. As an example, the power source unit 210 generates high-frequency AC power upon reception of power from a grid power source, not shown, and supplies thereupon the generated AC power to the power transmission unit 220.

The power transmission unit 220 is disposed in the floor of a parking lot. The power transmission unit 220 receives the supply of high-frequency AC power from the power source unit 210. The power transmission unit 220 outputs power to the power receiving unit 110 of the vehicle 100, in a contactless manner, through an electromagnetic field that is generated around the power transmission unit 220. The configuration of the power transmission unit 220 will be explained further on together with the configuration of the power receiving unit 110 and power transmission from the power transmission unit 220 to the power receiving unit 110. The communication unit 240 is a communication interface for communication of the power supply facility 200 with the vehicle 100.

In the vehicle power supply system 10, power is transmitted from the power transmission unit 220 of the power supply facility 200 to the power receiving unit 110 of the vehicle 100 in a contactless manner. In order to transmit power efficiently from the power supply facility 200 to the vehicle 100, the power receiving unit 110 and the power transmission unit 220 must be aligned with each other. In a case where the positions of the units are offset from each other, information relating to alignment must be displayed so as to be easily grasped by the driver, in order to prompt the driver to correct the parking position.

In the vehicle power supply system 10, accordingly, there is detected the distance between the power transmission unit 220 and the power receiving unit 110. The detected distance is indicated so as to be easily known visually by the driver. Specific display patterns are explained in detail further on. In an example of detection of the distance between the power transmission unit 220 and the power receiving unit 110, power for adjustment, which is smaller than transmission power upon full-blown power supply from the power supply facility 200 to the vehicle 100, is outputted to the power transmission unit 220, such that the distance can be detected on the basis of for instance, the power reception efficiency and the intensity of the voltage received by the power receiving unit 110 of the vehicle 100. The distance between the power transmission unit 220 and the power receiving unit 110 can be detected directly with a camera or a distance sensor. In such a case, however, costs rise in proportion to the camera or distance sensor that is installed.

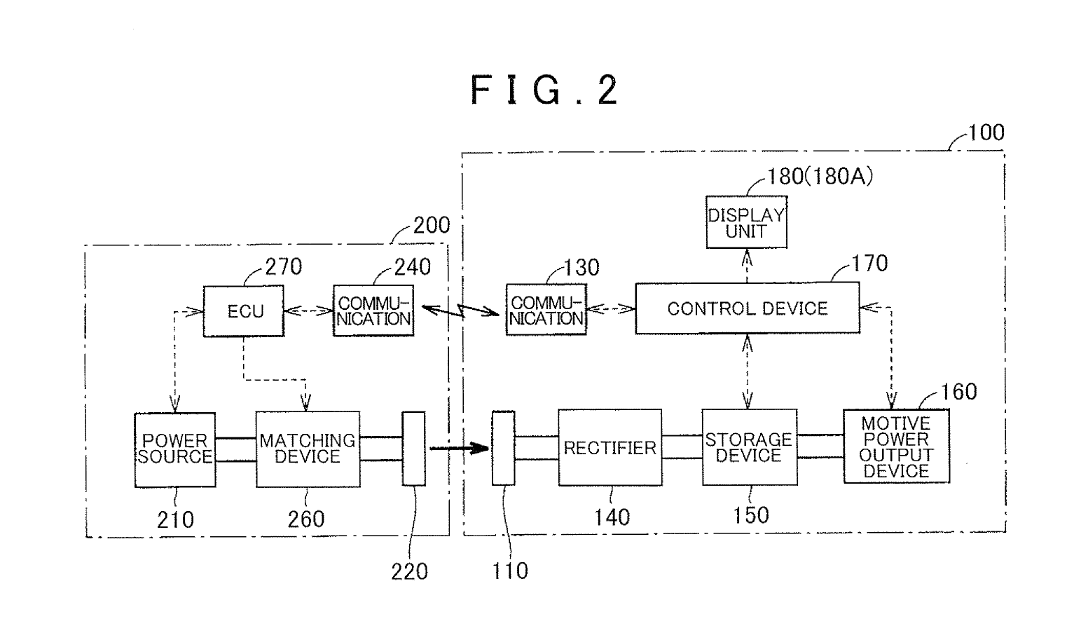

FIG. 2 is a functional block diagram for explaining in detail the configuration of the vehicle 100 and the power supply facility 200 illustrated in FIG. 1. With reference to FIG. 2, the vehicle 100 has the power receiving unit 110, a rectifier 140, a storage device 150, a motive power output device 160, a control device 170, the communication unit 130 and a display unit 180.

The rectifier 140 rectifies AC power received by the power receiving unit 110 and outputs the power to the storage device 150. The storage device 150 is a rechargeable DC power source, and is configured in the form of, for instance, a secondary battery such as a lithium ion or nickel-hydride battery. The storage device 150 stores power received from the rectifier 140. The storage device 150 stores also regenerative power that is generated by the motive power output device 160. The storage device 150 supplies the stored power to the motive power output device 160. A large-capacity capacitor may be used as the storage device 150.

The motive power output device 160 generates a travel driving force in the vehicle 100, using the power stored in the storage device 150. Although not specially depicted in the figures, the motive power output device 160 includes, for instance, an inverter that receives power from the storage device 150, a motor that is driven by the inverter, and drive wheels that are driven by the motor. The motive power output device 160 may also include a generator for charging the storage device 150, and an engine that is capable of driving the generator.

The control device 170 executes, in a central processing unit (CPU), a program stored beforehand. The vehicle 100 is controlled in various ways by software processing through execution of that program, and/or by hardware processing by dedicated electronic circuitry. Specifically, the control device 170 controls the motive power output device 160 and manages the charging of the storage device 150. The control device 170 can communicate wirelessly with the power supply facility 200 via the communication unit 130.

The control device 170 detects the distance between the power transmission unit 220 and the power receiving unit 110 when power is being supplied from the power supply facility 200 to the vehicle 100. As described above, the distance between the power transmission unit 220 and the power receiving unit 110 can be detected (estimated), for instance, on the basis of the voltage of the power received by the power receiving unit 110. The control device 170 outputs information on the detected distance to the display unit 180.

The display unit 180 displays, in a manner easy to know visually by the driver, the distance between the power transmission unit 220 and the power receiving unit 110 as detected by the control device 170. Specifically, the display unit 180 receives, from the control device 170, information on the distance between the power transmission unit 220 and the power receiving unit 110. On the basis of the distance information received from the control device 170, the display unit 180 displays then a concentric graphic, a size of which varies in accordance with the distance between the power transmission unit 220 and the power receiving unit 110. Specific display patterns are explained in detail further on. For instance, a screen of a car navigation device can be used as the display unit 180.

The power supply facility 200 has the power source unit 210, an impedance matching device 260, the power transmission unit 220, an electronic control unit (hereafter, ECU) 270, and the communication unit 240.

The impedance matching device 260 is provided between the power source unit 210 and the power transmission unit 220. The impedance matching device 260 is configured in such a manner that internal impedance can be modified. As an example, the impedance matching device 260 is consisting of a variable capacitor and a coil (not shown). Impedance can be modified by the impedance matching device 260 through changes in the capacity of the variable capacitor. The impedance of the power supply facility 200 and the impedance of the vehicle 100 can be matched to each other (impedance matching) through impedance modification by the impedance matching device 260. The impedance matching device 260 can be omitted if the power source unit 210 has an impedance matching function.

The ECU 270 controls the power source unit 210 and the impedance matching device 260 by software processing wherein a program stored beforehand is executed by the CPU, and/or by hardware processing by dedicated electronic circuitry. Specifically, the ECU 270 generates an operation start command and an operation stop command of the power source unit 210, as well as a power command value that denotes a target value of the output power of the power source unit 210, and outputs the foregoing to the power source unit 210. The ECU 270 controls the impedance matching device 260. The impedance of the power supply facility 200 is matched thereby to the impedance of the vehicle 100.

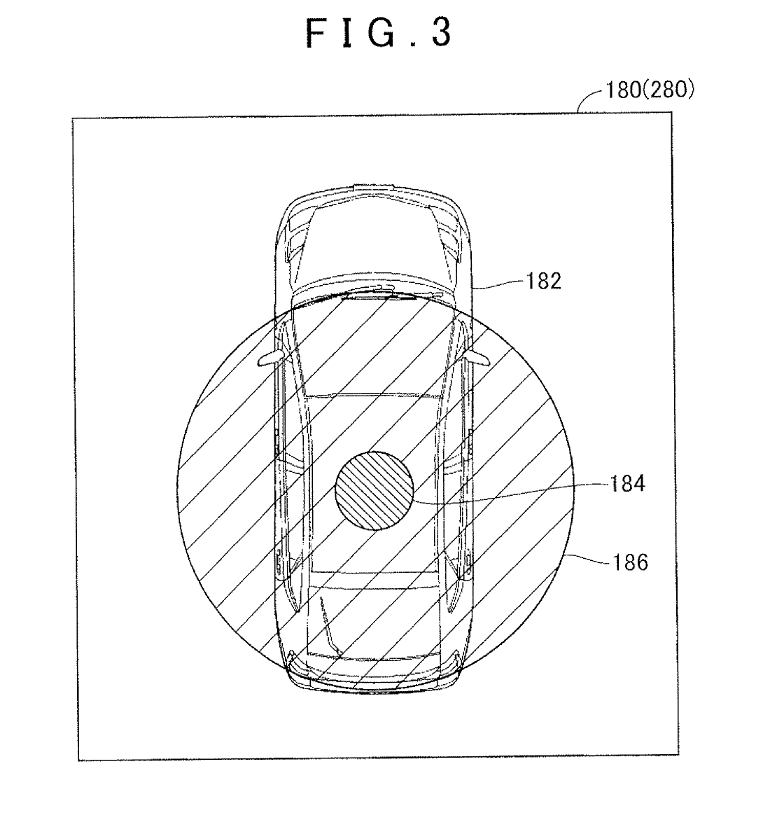

FIGS. 3 to 5 are diagrams illustrating display patterns of the graphic displayed on the display unit 180 that is depicted in FIG. 2. With reference to FIG. 3, the display unit 180 displays a top-view diagram 182 of the vehicle 100, and a top-view diagram 184 of the power receiving unit 110 (FIG. 1) that is installed in the vehicle 100. The top-view diagram 184 of the power receiving unit 110 is displayed as corresponding to the install position of the power receiving unit 110 in the vehicle 100. The top-view diagrams 182, 184 are displayed in a fixed manner within the display unit 180. The planar shape of the power receiving unit 110 is herein a circle, but is not limited to a circular shape.

The distance information display section 186 is displayed as a pattern that is concentric with the top-view diagram 184 of the power receiving unit 110. For instance, the distance information display section 186 has a pattern of a circle that is concentric with the top-view diagram 184. The display shape of the distance information display section 186 is not limited to a circle that is concentric with the top-view diagram 184. The size of the distance information display section 186 displayed on the display unit, on the basis of information on the distance between the power transmission unit 220 and the power receiving unit 110 as received from the control device 170 (FIG. 2). Specifically, the size of the distance information display section 186 increased as the distance between the power transmission unit 220 and the power receiving unit 110 increases, and decreases as the distance between the power transmission unit 220 and the power receiving unit 110 decreases. FIG. 3 illustrates an instance where the distance between the power transmission unit 220 and the power receiving unit 110 is relatively large.

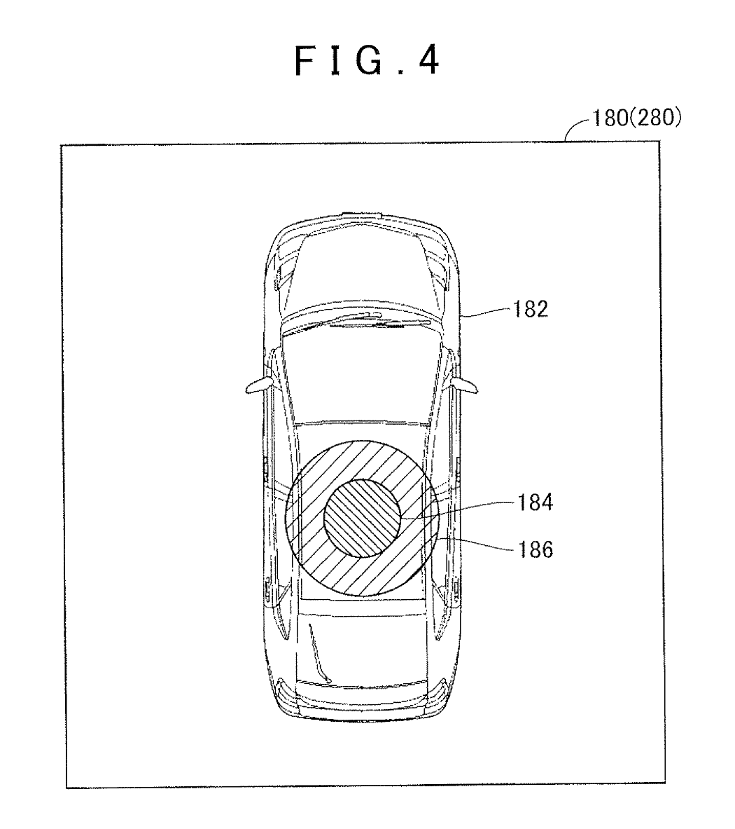

With reference to FIG. 4, when the distance between the power transmission unit 220 and the power receiving unit 110 becomes smaller than the distance in the instance illustrated in FIG. 3, as a result of movement of the vehicle 100, the size of the distance information display section 186 decreases accordingly. As regards movement of the vehicle 100, the driver may prompt movement of the vehicle 100 manually, or automatically by way of, for instance, a parking assist function or the like, not shown.

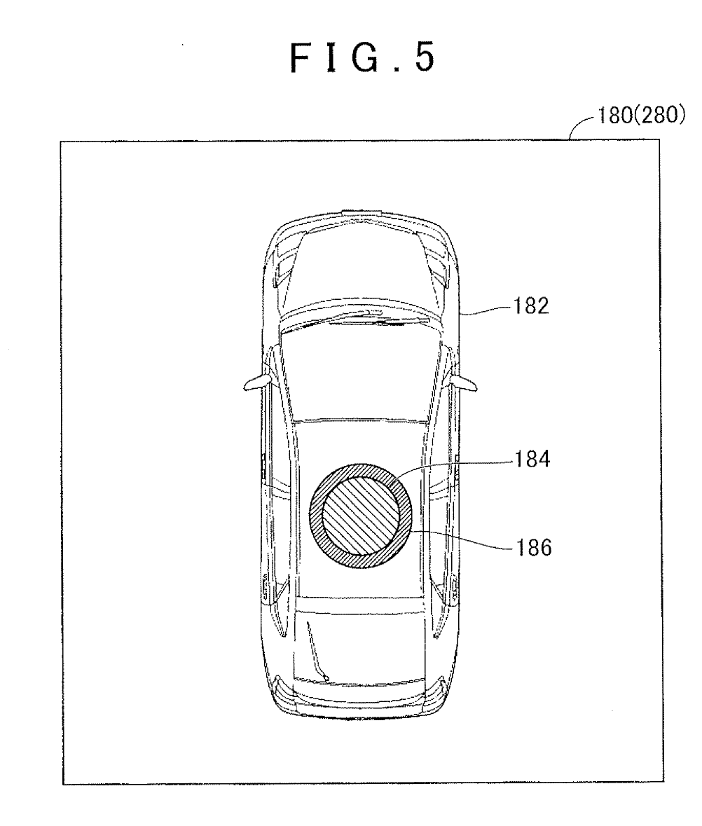

With reference to FIG. 5, when the distance between the power transmission unit 220 and the power receiving unit 110 further becomes smaller than the distance in the instance illustrated in FIG. 4, as a result of movement of the vehicle 100, the size of the distance information display section 186 becomes accordingly yet smaller. FIG. 5 illustrates an instance where alignment of the power transmission unit 220 and the power receiving unit 110 is substantially over.

The display color or the display brightness of the distance information display section 186 may vary accompanying changes in the size of the distance information display section 186, as illustrated in FIGS. 3 to 5. For instance, when the distance between the power transmission unit 220 and the power receiving unit 110 is relatively large (FIG. 3), the brightness of the display of the distance information display section 186 may become lighter, while the brightness of the display of the distance information display section 186 may become darker as the distance between the power transmission unit 220 and the power receiving unit 110 becomes smaller (FIGS. 4 and 5).

The display unit 180 varies the size of the distance information display section 186 responding the movement of the vehicle 100. That is, the control device 170 detects, moment by moment, the distance between the power transmission unit 220 and the power receiving unit 110 accompanying the movement of the vehicle 100, upon movement of the vehicle 100 for alignment between the power transmission unit 220 and the power receiving unit 110 (which, as described above, may be a manual operation by the driver or an automatic operation by a parking assist function or the like). The control device 170 outputs information on the detected distance to the display unit 180. The display unit 180 varies the size of the distance information display section 186, moment by moment, on the basis of the distance information received from the control device 170.

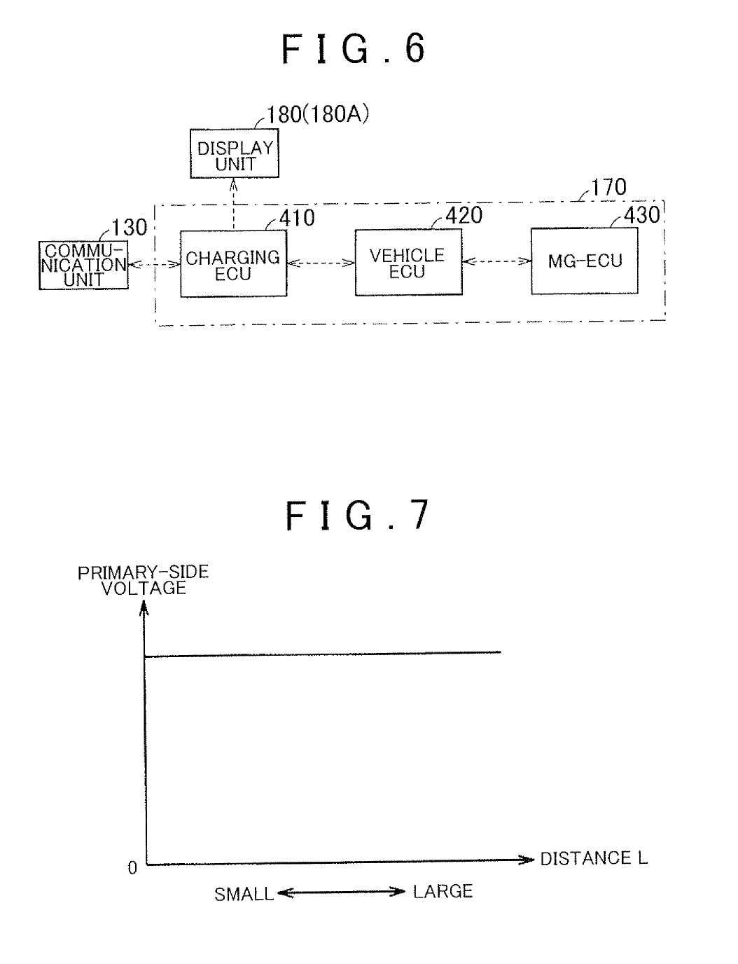

FIG. 6 is a detailed configuration diagram of the control device 170 illustrated in FIG. 2. With reference to FIGS. 6 and 2, the control device 170 includes a charging ECU 410, a vehicle ECU 420 and an MG-ECU 430. The charging ECU 410 receives, via the communication unit 130, information on power that is sent from the power supply facility 200. The charging ECU 410 detects the voltage received by the power receiving unit 110 (hereafter also referred to as “power reception voltage”). The power reception voltage is detected by a voltage sensor or the like, not shown. The charging ECU 410 detects the distance between the power transmission unit 220 of the power supply facility 200 and the power receiving unit 110 of the vehicle 100 by comparing, with the communication unit 130, the received power transmission voltage from the power supply facility 200 and the power reception voltage by the power receiving unit 110.

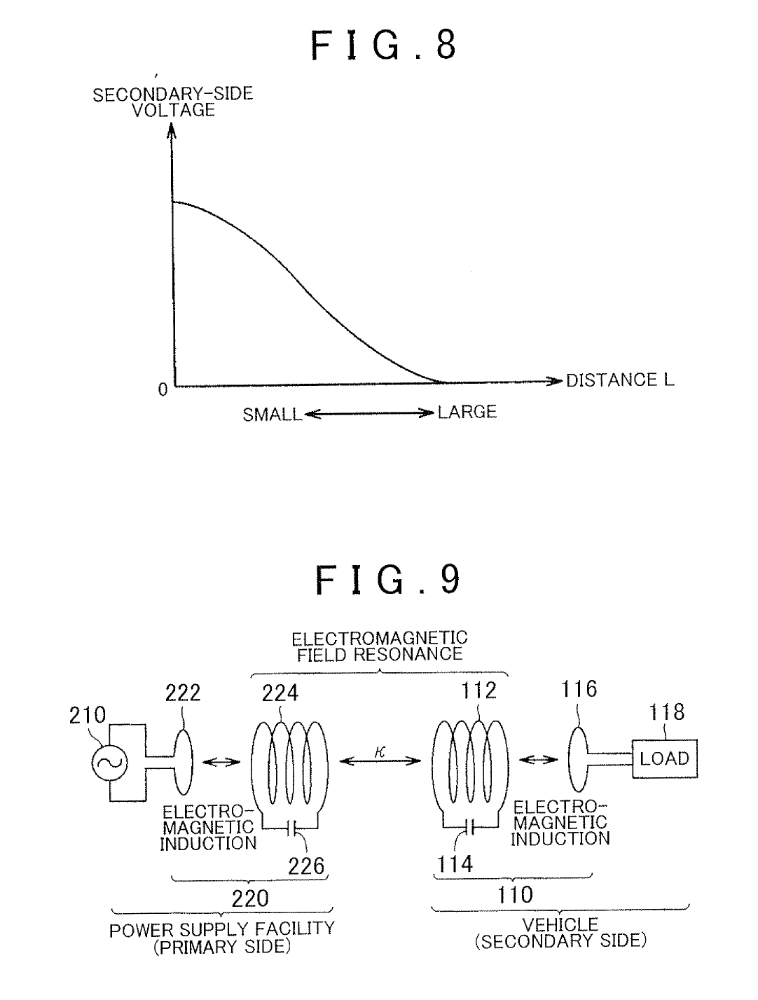

Specifically, a secondary-side voltage (power reception voltage of the vehicle 100) varies, in accordance with a distance L between the power transmission unit 220 of the power supply facility 200 and the power receiving unit 110 of the vehicle 100, as illustrated in FIG. 8, with respect to a constant primary-side voltage (output voltage from the power supply facility 200), such as the one illustrated in FIG. 7. Accordingly, a map or the like is created, for instance through measurement, beforehand, of a relationship between the primary-side voltage and the secondary-side voltage, as illustrated in FIGS. 7 and 8. The distance between the power transmission unit 220 and the power receiving unit 110 can be detected as a result on the basis of the detection value of the secondary-side voltage (power reception voltage of the vehicle 100).

Although not particularly illustrated in the figures, the reception power of the vehicle 100 may be used instead of the power reception voltage of the vehicle 100. Alternatively, the distance between the power transmission unit 220 and the power receiving unit 110 may be detected on the basis of a detection value of output current from the power supply facility 200, by exploiting a relationship whereby the primary-side current (output current from the power supply facility 200) varies in accordance with the distance L between the power transmission unit 220 and the power receiving unit 110.

Returning to FIG. 6, upon detection of the distance between the power transmission unit 220 and the power receiving unit 110, the charging ECU 410 outputs, to the display unit 180 and the vehicle ECU 420, information on the distance between the power transmission unit 220 and the power receiving unit 110. Upon reception of a charging start command from the vehicle ECU 420, the charging ECU 410 executes charging control of the storage device 150 by the power supply facility 200, and outputs, to the communication unit 130, a command for instructing full-blown power supply from the power supply facility 200 to the vehicle 100.

When the operation mode of the vehicle is a travel mode, the vehicle ECU 420 outputs, to the MG-ECU 430, a command of instructing execution of travel control by the motive power output device 160. When the operation mode of the vehicle is a charging mode, the vehicle ECU 420 outputs, to the charging ECU 410, a command of instructing execution of charging control of the storage device 150 by the power supply facility 200. The MG-ECU 430 outputs a control command to the motive power output device 160 in accordance with, for instance, the operation situation of an accelerator pedal/brake pedal and the travel situation of the vehicle and so forth.

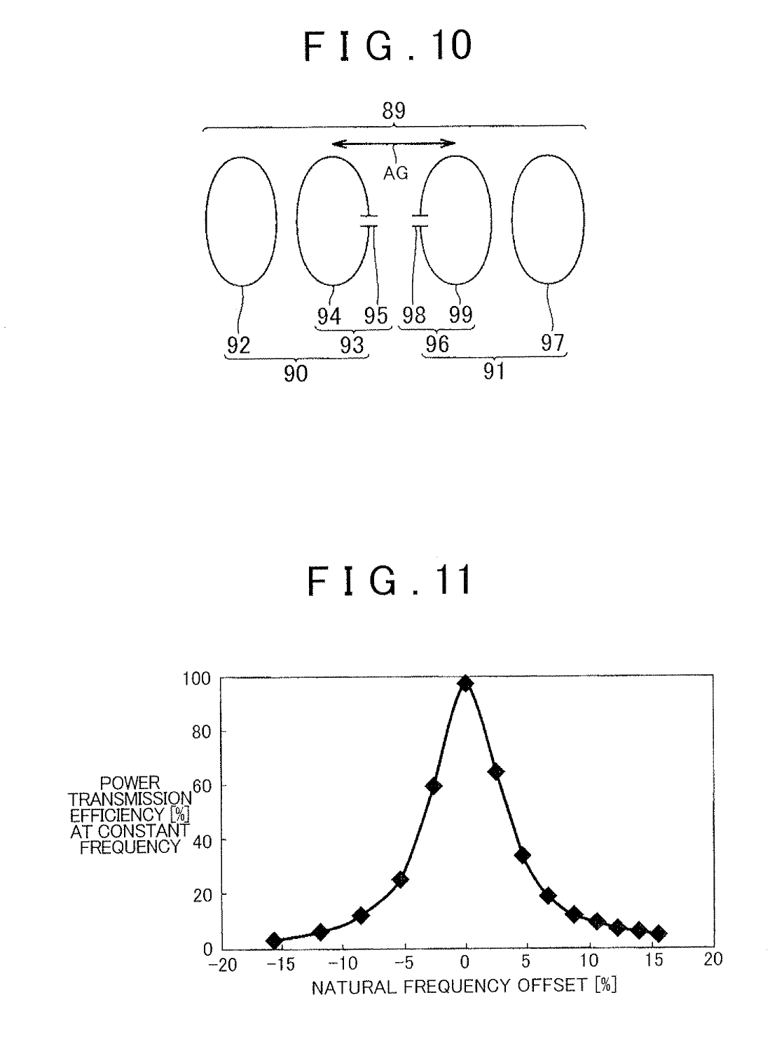

Power transmission from the power supply facility 200 to the vehicle 100 is explained next. FIG. 9 is an equivalent circuit diagram at a time of power transmission from the power supply facility 200 to the vehicle 100. With reference to FIG. 9, the power transmission unit 220 of the power supply facility 200 has an electromagnetic induction coil 222, a resonant coil 224 and a capacitor 226.

The electromagnetic induction coil 222 is disposed substantially coaxially with the resonant coil 224, with a predetermined interval with respect to the resonant coil 224. The electromagnetic induction coil 222 is magnetically coupled, by electromagnetic induction, to the resonant coil 224. The electromagnetic induction coil 222 supplies to the resonant coil 224, by electromagnetic induction, high-frequency power that is supplied from the power source unit 210.

The resonant coil 224 forms an LC resonant circuit together with the capacitor 226. As described below, an LC resonant circuit is also formed in the power receiving unit 110 of the vehicle 100. The difference between the natural frequency of the LC resonant circuit that is formed by the resonant coil 224 and the capacitor 226, and the natural frequency of the LC resonant circuit of the power receiving unit 110, is no greater than ±10% of the natural frequency of the former or the natural frequency of the latter. The resonant coil 224 receives power, by electromagnetic induction, from the electromagnetic induction coil 222, and transmits power to the power receiving unit 110 of the vehicle 100 in a contactless manner.

The electromagnetic induction coil 222 is provided for the purpose of facilitating supply of power from the power source unit 210 to the resonant coil 224. Therefore, the electromagnetic induction coil 222 may be omitted, and the power source unit 210 may be connected directly to the resonant coil 224. The capacitor 226 is provided for the purpose of adjusting the natural frequency of the resonant circuit. The capacitor 226 may be omitted in cases where a desired natural frequency is obtained by utilizing the stray capacitance of the resonant coil 224.

The power receiving unit 110 of the vehicle 100 has a resonant coil 112, a capacitor 114 and an electromagnetic induction coil 116. The resonant coil 112 forms an LC resonant circuit together with the capacitor 114. The difference between the natural frequency of the LC resonant circuit that is formed by the resonant coil 112 and the capacitor 114, and the natural frequency of the LC resonant circuit that is formed by the resonant coil 224 and the capacitor 226 in the power transmission unit 220 of the power supply facility 200, is no greater than ±10% of the natural frequency of the former or the natural frequency of the latter. The resonant coil 112 receives power from the power transmission unit 220 of the power supply facility 200 in a contactless manner.

The electromagnetic induction coil 116 is disposed substantially coaxially with the resonant coil 112, with a predetermined interval with respect to the resonant coil 112. The electromagnetic induction coil 116 is magnetically coupled, by electromagnetic induction, to the resonant coil 112. The electromagnetic induction coil 116 extracts, by electromagnetic induction, power received by way of the resonant coil 112, and outputs the power to an electrical load 118 (storage device 150) from the rectifier 140 (FIG. 1) onwards.

The electromagnetic induction coil 116 is provided for the purpose of extracting power easily from the resonant coil 112. Therefore, the electromagnetic induction coil 116 may be omitted, and the rectifier 140 may be connected directly to the resonant coil 112. The capacitor 114 is provided for the purpose of adjusting the natural frequency of the resonant circuit. The capacitor 114 may be omitted in cases where a desired natural frequency is obtained by utilizing the stray capacitance of the resonant coil 112.

In the power supply facility 200, high-frequency AC power is supplied from the power source unit 210 to the electromagnetic induction coil 222. Power is supplied to the resonant coil 224 using the electromagnetic induction coil 222. Thereupon, energy (power) is transferred from the resonant coil 224 to the resonant coil 112 through the magnetic field that is formed between the resonant coil 224 and the resonant coil 112 of the vehicle 100. Energy (power) transferred to the resonant coil 112 is extracted using the electromagnetic induction coil 116, and is transmitted to the electrical load 118 of the vehicle 100.

Returning to FIG. 2, the difference between the natural frequency of the power transmission unit 220 of the power supply facility 200 and the natural frequency of the power receiving unit 110 of the vehicle 100, in the power transmission system, is no greater than ±10% of the natural frequency of the power transmission unit 220 or the natural frequency of the power receiving unit 110. Power transmission efficiency can be increased by setting the natural frequencies of the power transmission unit 220 and the power receiving unit 110 to lie within such a range. By contrast, power transmission efficiency becomes lower than 10% if the difference between the abovementioned natural frequencies exceeds ±10%. Negative effects such as, for instance, longer power transmission time arise as a result.

The natural frequency of the power transmission unit 220 (power receiving unit 110) denotes herein the oscillation frequency in a case where an electric circuit (resonant circuit) that makes up the power transmission unit 220 (power receiving unit 110) oscillates freely. The natural frequency at a time where braking forces or electric resistance are substantially zero, in the electric circuit (resonant circuit) that makes up the power transmission unit 220 (power receiving unit 110), may also be referred to as the resonance frequency of the power transmission unit 220 (power receiving unit 110).

An explanation follows next, with reference to FIGS. 10 and 11, on results of a simulation of the relationship between power transmission efficiency and difference in natural frequencies. FIG. 10 is a diagram illustrating a simulation model of the power transmission system. FIG. 11 is a diagram illustrating the relationship between power transmission efficiency and the offset in natural frequency between a power transmission unit and a power receiving unit.

With reference to FIG. 10, a power transmission system 89 is provided with a power transmission unit 90 and a power receiving unit 91. The power transmission unit 90 includes a first coil 92 and a second coil 93. The second coil 93 includes a resonant coil 94 and a capacitor 95 that is provided in the resonant coil 94. The power receiving unit 91 is provided with a third coil 96 and a fourth coil 97. The third coil 96 includes a resonant coil 99 and a capacitor 98 connected to the resonant coil 99.

Herein, inductance Lt is the inductance of the resonant coil 94 and capacitance C1 is the capacitance of the capacitor 95. Also, inductance Lr is the inductance of the resonant coil 99 and capacitance C2 is the capacitance of the capacitor 98. With these parameters set, a natural frequency f1 of the second coil 93 is given by Expression (1) below, and a natural frequency f2 of the third coil 96 is given Expression (2) below.

f1=1/{2π(Lt×C1)^{1/2}} (1)

f2=1/{2π(Lr×C2)^{1/2}} (2)

FIG. 11 illustrates the relationship between power transmission efficiency and offset between the natural frequencies of the second coil 93 and the third coil 96, in a case where the inductance Lr and the capacitances C1 and C2 are fixed and only the inductance Lt is caused to vary. In this simulation, the relative positional relationship between the resonant coil 94 and the resonant coil 99 is fixed, and the frequency of the current supplied to the second coil 93 is constant.

In the graph illustrated in FIG. 11, the abscissa axis represents the offset (%) in natural frequency, and the ordinate axis represents power transmission efficiency (%) at constant frequency. The offset (%) in natural frequency is given by Expression (3).

(natural frequency offset)={(f1−f2)/f2}×100(%) (3)

As FIG. 11 shows, the power transmission efficiency is close to 100% when the natural frequency offset (%) is 0%. The power transmission efficiency is about 40% when the natural frequency offset (%) is ±5%. The power transmission efficiency is about 10% when the natural frequency offset (%) is ±10%. The power transmission efficiency is about 5% when the natural frequency offset (%) is ±15%. That is, the natural frequencies of the second coil 93 and the third coil 96 are set in such a manner that the absolute value (difference between natural frequencies) of the natural frequency offset (%) is no greater than 10% of the natural frequency of the third coil 96. It is found that the power transmission efficiency can be increased to a practicable level as a result. The natural frequencies of the second coil 93 and the third coil 96 are set in such a manner that the absolute value of the natural frequency offset (%) is no greater than 5% of the natural frequency of the third coil 96. Accordingly, the power transmission efficiency can be further increased. An electromagnetic field analysis software package (JMAG™, by ISM) is used as the simulation software.

Returning to FIG. 2, power is exchanged, in a contactless manner, between the power transmission unit 220 of the power supply facility 200 and the power receiving unit 110 of the vehicle 100 through at least one of the magnetic field formed between the power transmission unit 220 and the power receiving unit 110 and that oscillates at a specific frequency, and the electric field that is formed between power transmission unit 220 and the power receiving unit 110 and that oscillates at a specific frequency. Preferably, a coupling coefficient (κ) between the power transmission unit 220 and the power receiving unit 110 is no greater than 0.1. Power is transmitted from the power transmission unit 220 to the power receiving unit 110 through resonance elicited by the electromagnetic field between the power transmission unit 220 and the power receiving unit 110.

An explanation follows next on the magnetic field, of specific frequency, that is formed around the power transmission unit 220. The “magnetic field of specific frequency” is typically associated with the power transmission efficiency and the frequency of the current that is supplied to the power transmission unit 220. Accordingly, an explanation follows first on the relationship between power transmission efficiency and the frequency of the current that is supplied to the power transmission unit 220. The power transmission efficiency upon transmission of power from the power transmission unit 220 to the power receiving unit 110 varies depending on several factors, for instance the distance between the power transmission unit 220 and the power receiving unit 110. For instance, f0 is the natural frequency (resonance frequency) of the power transmission unit 220 and the power receiving unit 110, f3 is the frequency of the current that is supplied to the power transmission unit 220, and air gap AG is the air gap between the power transmission unit 220 and the power receiving unit 110.

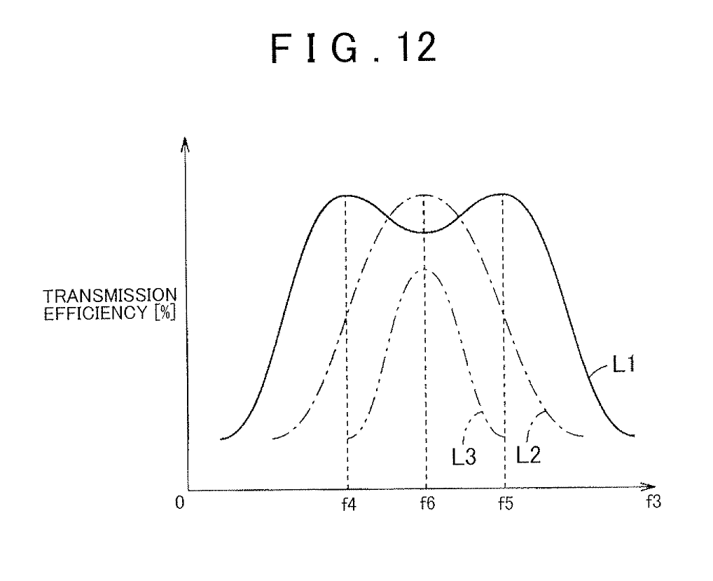

FIG. 12 is a graph illustrating the relationship between the power transmission efficiency upon changes in the air gap AG and the frequency f3 of the current supplied to the power transmission unit 220, in a state where the natural frequency ID is fixed. With reference to FIG. 12, the abscissa axis represents the frequency f3 of the current supplied to the power transmission unit 220, and the ordinate axis represents the power transmission efficiency (%). Efficiency curve L1 represents schematically the relationship between the power transmission efficiency, when the air gap AG is small, and the frequency f3 of the current supplied to the power transmission unit 220. As efficiency curve L1 indicates, peaks of power transmission efficiency occur at frequencies f4 and f5 (f4<f5) when the air gap AG is small. As the air gap AG increases, the two peaks at a time where the power transmission efficiency is high shift so as to come closer to each other. The peaks of power transmission efficiency become one peak when the air gap AG increases beyond a predetermined distance, as indicated by efficiency curve L2. The power transmission efficiency reaches a peak when the frequency of the current supplied to the power transmission unit 220 is frequency f6. The peak of the power transmission efficiency becomes smaller, as indicated by efficiency curve L3, as the air gap AG grows larger beyond the state of efficiency curve L2.

Conceivable methods for enhancing the power transmission efficiency may be for instance as follows. In a first method, the frequency of the current that is supplied to the power transmission unit 220 is set to be constant, and the capacitances of the capacitor 226 and the capacitor 114 is caused to vary, according to the air gap AG; as a result, there varies the characteristic of the power transmission efficiency between the power transmission unit 220 and the power receiving unit 110. Specifically, in a state where the frequency of the current supplied to the power transmission unit 220 is kept constant, the capacitances of the capacitor 226 and the capacitor 114 are adjusted in such a manner that the power transmission efficiency reaches a peak. In this method, the frequency of the current that flows in the power transmission unit 220 and the power receiving unit 110 is constant, irrespective of the extent of the air gap AG. A method used for varying the characteristic of the power transmission efficiency may be, for instance, a method that relies on the impedance matching device 260 of the power supply facility 200, or a method that utilizes a converter provided between the rectifier 140 and the storage device 150, in the vehicle 100.

The second method is a method of adjusting the frequency of the current supplied to the power transmission unit 220 on the basis of the extent of the air gap AG. For instance, current of frequency f4 or f5 is supplied to the power transmission unit 220 in a case where the power transmission characteristic corresponds to efficiency curve L1. Current of frequency f6 is supplied to the power transmission unit 220 in a case where the power transmission characteristic corresponds to efficiency curve L2 or L3. In this ease, the frequency of the current that flows in the power transmission unit 220 and the power receiving unit 110 is caused to vary according to the extent of the air gap AG.

In the first method, the frequency of the current flowing in the power transmission unit 220 is a fixed given frequency, while in the second method, the frequency of current flowing in the power transmission unit 220 is a frequency that changes appropriately in accordance with the air gap AG. Current of a specific frequency set so as to increase power transmission efficiency is supplied to the power transmission unit 220, in accordance with the first or the second method. Flow of current of a specific frequency in the power transmission unit 220 causes a magnetic field (electromagnetic field), which oscillates at the specific frequency, to be formed around the power transmission unit 220. The power receiving unit 110 receives power, from the power transmission unit 220, through the magnetic field that is formed between the power receiving unit 110 and the power transmission unit 220 and that oscillates at the specific frequency. In consequence, the “magnetic field that oscillates at the specific frequency” is not necessarily limited to a magnetic field of fixed frequency. In the above-described example, the frequency of current that is supplied to the power transmission unit 220 is set focusing on the air gap AG. However, the power transmission efficiency varies also on account of other factors, for instance, the offset of the power transmission unit 220 and the power receiving unit 110 with respect to the horizontal direction. Therefore, the frequency of the current that is supplied to the power transmission unit 220 may be adjusted in some instances on the basis of factors other than the above-described ones.

In the explanation above, an example has been illustrated wherein a helical coil is used as the resonant coil. However, in a case where an antenna such as a meander line is used as the resonant coil, an electric field of a specific frequency is formed around the power transmission unit 220 as a result of current of a specific frequency flowing in the power transmission unit 220. Power is then transmitted between the power transmission unit 220 and the power receiving unit 110 through this electric field.

In the power transmission system, the power transmission and power reception efficiency are enhanced through the use of a near field (evanescent field) in which the “electrostatic field” of the electromagnetic field is dominant.

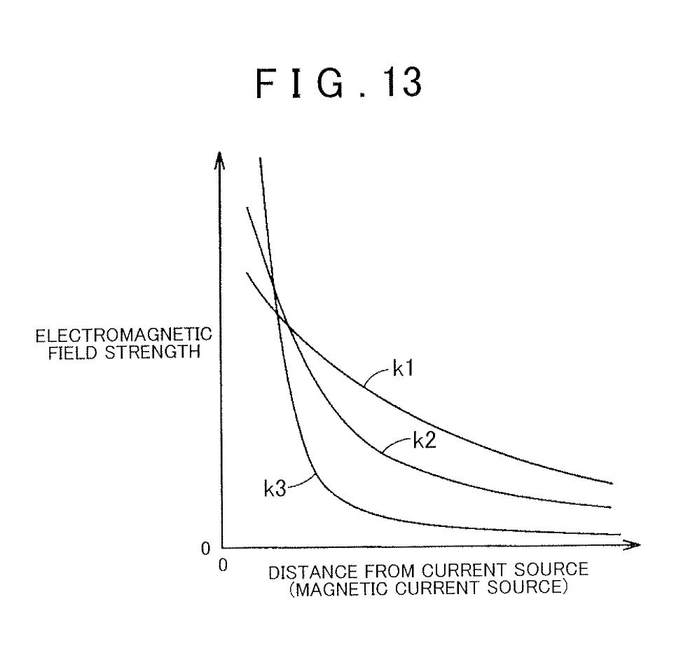

FIG. 13 is a diagram illustrating the relationship between the distance from a current source (magnetic current source) and the intensity of an electromagnetic field. With reference to FIG. 13, an electromagnetic field includes three components. Herein, curve k1 is a component inversely proportional to the distance from a wave source and is referred to as “radiation electric field”, curve k2 is a component inversely proportional to the square of the distance from a wave source and is referred to as “induced electric field”, and curve k3 is a component inversely proportional to the cube of the distance from a wave source and is referred to as “electrostatic field”. The distance at which the strengths of the “radiation electric field”, the “induced electric field” and the “electrostatic field” are substantially identical is λ/2π, where “λ” denotes the wavelength of the electromagnetic field.

The “electrostatic field” is a region at which the intensity of electromagnetic waves drops abruptly with increasing distance from the wave source. In the power transmission system according to Embodiment 1, transmission of energy (power) is accomplished by exploiting a near field (evanescent field) in which the “electrostatic field” is dominant. That is, the power transmission unit 220 and the power receiving unit 110 (for instance, a pair of LC resonant coils) that have natural frequencies that are close to each other resonate in a near field, where the “electrostatic field” is dominant, and energy (power) is transmitted as a result from the power transmission unit 220 to the other power receiving unit 110. Energy does not propagate far in the case of the “electrostatic field”. Therefore, power transmission can be achieved, by resonance, with smaller energy loss as compared with an instance in which electromagnetic waves transmit energy (power) by way of the “radiation electric field”, in which case energy propagates to far distances.

In the power transmission system, thus, power is transmitted, in a contactless manner, between the power transmission unit 220 and the power receiving unit 110, through resonance, mediated by an electromagnetic field, between the power transmission unit 220 and the power receiving unit 110. Preferably, the coupling coefficient (κ) between the power transmission unit 220 and the power receiving unit 110 is no greater than 0.1. The coupling coefficient (κ) is not limited to this value, and may take on various values that result in good power transmission. In power transmission by electromagnetic induction, the coupling coefficient (κ) between a power transmission unit and a power receiving unit is ordinarily close to 1.0.

In power transmission, coupling between the power transmission unit 220 and the power receiving unit 110, such as the abovementioned coupling, denotes, for instance, “magnetic resonant coupling”, “magnetic field resonant coupling”, “electromagnetic field resonant coupling”, “electric field resonant coupling” and the like. Herein, “electromagnetic field resonant coupling” denotes coupling that includes any coupling from among “magnetic resonant coupling”, “magnetic field resonant coupling” and “electric field resonant coupling”.

In a case where the power transmission unit 220 and the power receiving unit 110 are formed by coils, as described above, the power transmission unit 220 and the power receiving unit 110 are coupled mainly by a magnetic field, and there is formed “magnetic resonant coupling” or “magnetic field resonant coupling”. For instance, an antenna such as a meander line can be used in the power transmission unit 220 and the power receiving unit 110. In this case, the power transmission unit 220 and the power receiving unit 110 are coupled mainly by an electric field, and “electric field resonant coupling” is formed.

In Embodiment 1, as described above, power is transmitted from the power supply facility 200 to the vehicle 100 in a contactless manner. Also, the distance between the power transmission unit 220 of the power supply facility 200 and the power receiving unit 110 of the vehicle 100 is detected. The display unit 180 displays the distance information display section 186 and varies the size of the distance information display section 186 in accordance with the detected distance. Specifically, the size of the distance information display section 186 displayed on the display unit 180 increases as the distance between the power transmission unit 220 and the power receiving unit 110 increases, and decreases as the distance between the power transmission unit 220 and the power receiving unit 110 decreases. As a result, the user of the vehicle 100 can know visually the distance between the power transmission unit 220 of the power supply facility 200 and the power receiving unit 110 of the vehicle 100 by seeing the size of the distance information display section 186 that is displayed on the display unit 180. Therefore, Embodiment 1 allows the user to easily know visually the distance between the power transmission unit 220 of the power supply facility 200 and the power receiving unit 110 of the vehicle 100.

In Embodiment 1, the display unit 180 varies the size of the pattern that is depicted by the distance information display section 186 to indicate the distance between the power transmission unit 220 and the power receiving unit 110. However, the display unit 180 may varies a flashing rate of display of a pattern to indicate the distance between the power transmission unit 220 and the power receiving unit 110.

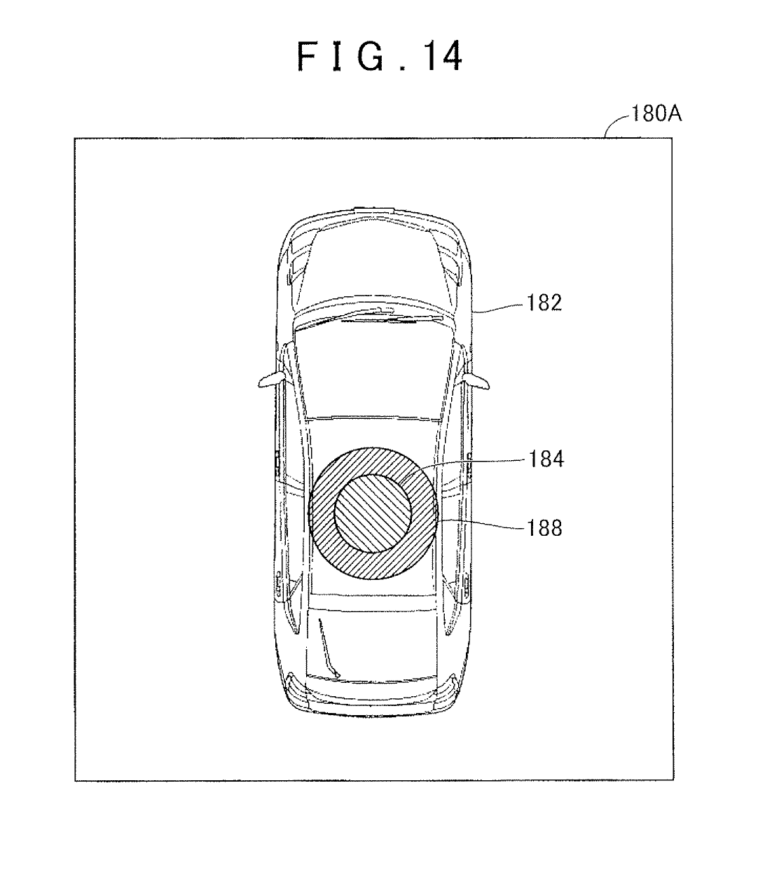

FIG. 14 is a diagram illustrating a display pattern of the graphic displayed on the display unit in this variation. With reference to FIG. 14, a display unit 180A includes a distance information display section 188, instead of the distance information display section 186 in the configuration of the display unit 180 illustrated in FIGS. 3 to 5.

The distance information display section 188, which is a pattern that is concentric with the top-view diagram 184 of the power receiving unit 110, flashes. In FIG. 14 as well, the distance information display section 188 is a pattern of a circle concentric with the top-view diagram 184, but the display shape of the distance information display section 188 is not limited to a circle that is concentric with the top-view diagram 184. The flashing rate of the distance information display section 188 displayed on the display unit varies on the basis of information on the distance between the power transmission unit 220 and the power receiving unit 110 as received from the control device 170 (FIG. 2). Specifically, the flashing rate of the distance information display section 188 decreases as the distance between the power transmission unit 220 and the power receiving unit 110 increases, and increases as the distance between the power transmission unit 220 and the power receiving unit 110 decreases. The change gradient in the flashing rate may be the opposite of the above.

A display color of the distance information display section 188 or the brightness of the display of the distance information display section 188 may vary, instead of the flashing rate of the distance information display section 188, according to the distance between the power transmission unit 220 and the power receiving unit 110.

This variation elicits the same effects as in the case of Embodiment 1.

In Embodiment 2, notification sound is generated according to changes in the display pattern by the display unit 180 (180A), in addition to the visual display by the display unit 180 (180A).

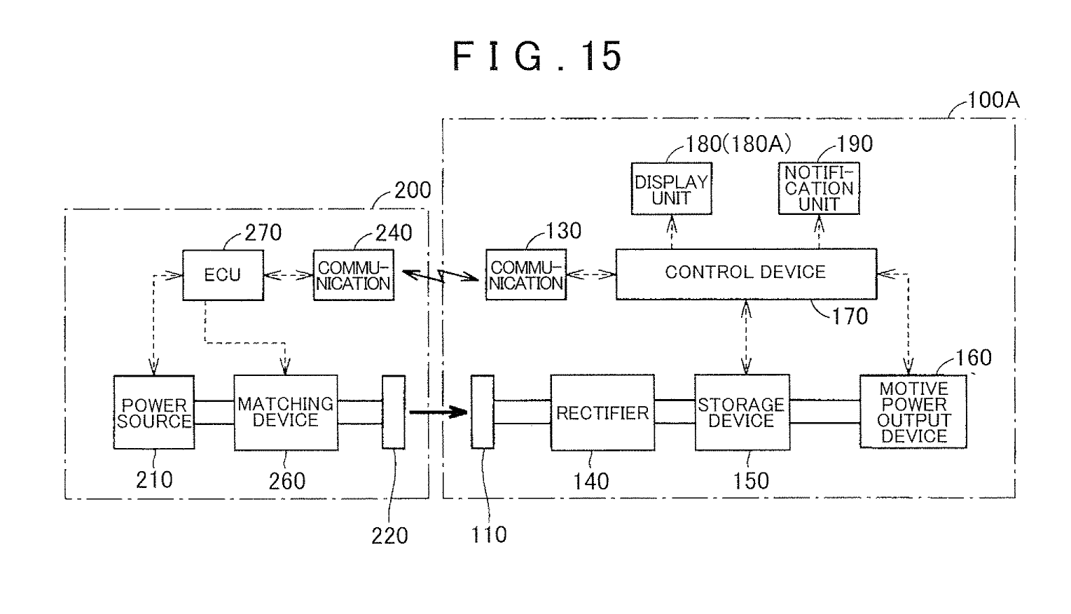

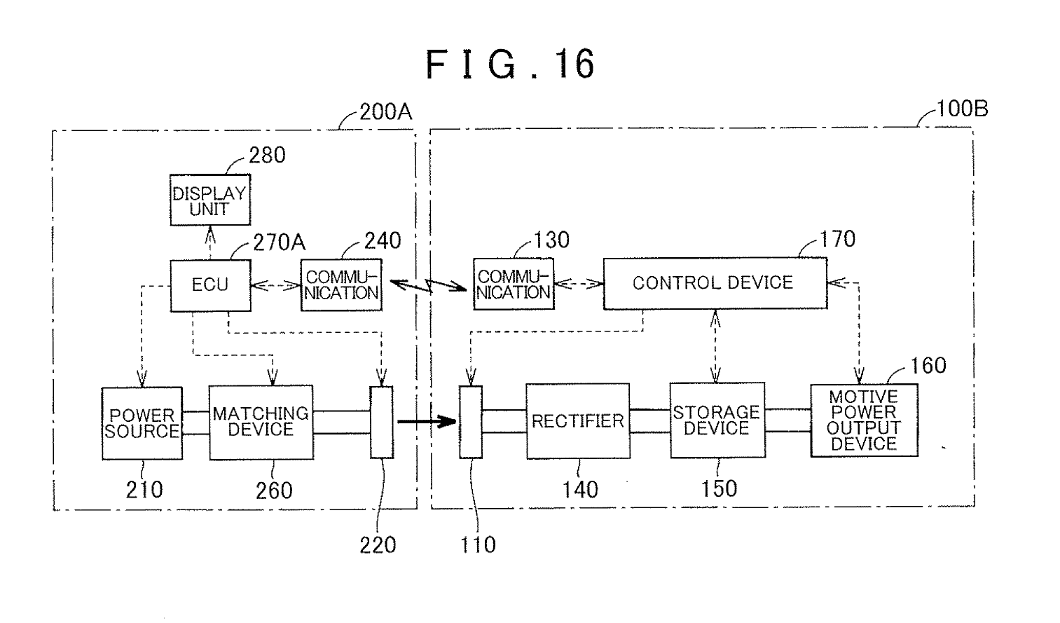

FIG. 15 is a functional block diagram for explaining the configuration of the vehicle in Embodiment 2. With reference to FIG. 15, a vehicle 100A in Embodiment 2 further has a notification unit 190 in the configuration of the vehicle 100 in Embodiment 1 illustrated in FIG. 2.

The notification unit 190 generates a notification sound according to changes in the display pattern by the display unit 180 (180A). As an example, the notification unit 190 lengthens the duration of the notification sound in a case where the distance information display section 186 indicates that the distance between the power transmission unit 220 and the power receiving unit 110 is relatively large, as illustrated in FIG. 3. Specifically, one notification sound may be caused to sound for a longer time, or the interval between notification sounds may be lengthened. By contrast, the notification unit 190 shortens the duration of the notification sound in a case where the distance information display section 186 indicates that the distance between the power transmission unit 220 and the power receiving unit 110 is relatively small, as illustrated in FIG. 5. Specifically, one notification sound may be caused to sound for a shorter time, or the interval between notification sounds may be shortened.

Instead of the duration of the sound, the notification unit 190 may cause the pitch of the sound to rise or fall. More directly, the notification unit 190 may generate a notification sound according to changes in the distance between the power transmission unit 220 and the power receiving unit 110 as detected by the control device 170.

In Embodiment 2, the notification unit 190 is provided in addition to the display unit 180 (180A), and hence the user can perceive, through sound as well, the distance between the power transmission unit 220 of the power supply facility 200 and the power receiving unit 110 of the vehicle 100.

In Embodiments 1 and 2, the display unit that indicates the distance between the power transmission unit 220 of the power supply facility 200 and the power receiving unit 110 of the vehicle 100 is provided in the vehicle, but in Embodiment 3 the display unit is provided in the power supply facility.

FIG. 16 is a functional block diagram for explaining the configuration of a vehicle and a power supply facility in Embodiment 3. With reference to FIG. 16, the configuration of a vehicle 100B in Embodiment 3 is identical to that of the vehicle 100 illustrated in FIG. 2, except that herein no display unit 180 is provided. Instead, a power supply facility 200A further has a display unit 280, in the configuration of the power supply facility 200 illustrated in FIG. 2, and has an ECU 270A instead of the ECU 270.

The display unit 280 indicates the distance between the power transmission unit 220 and the power receiving unit 110 so that the user can visually know the distance. The display patterns of the display unit 280 are identical to those of the display unit 180 in Embodiment 1 illustrated in FIGS. 3 to 5, or those of the display unit 180A illustrated in FIG. 14. The distance between the power transmission unit 220 and the power receiving unit 110 is detected by the ECU 270A or the control device 170 of the vehicle 100B. In a case where the distance is detected by the control device 170 of the vehicle 100B, information on the detected distance is transmitted from the vehicle 100B to the power supply facility 200A by the communication units 130, 240.

The ECU 270A detects the distance between the power transmission unit 220 and the power receiving unit 110 when power is being supplied from the power supply facility 200A to the vehicle 100B. The distance can be detected (estimated) in accordance with the method explained with reference to FIGS. 7 and 8, through reception, by way of the communication units 130, 240, of the detection value of voltage received by the power receiving unit 110 from the vehicle 100B. The ECU 270A outputs, to the display unit 280, information on the detected distance. As in Embodiments 1 and 2, the vehicle 10013 may detect the distance between the power transmission unit 220 and the power receiving unit 110, and the ECU 270A may receive, from the vehicle 100B, the detection result, by way of the communication unit 240.

Although not particularly shown in the figure, the power supply facility 200A may be provided with a notification unit that generates a notification sound in accordance with changes in the display pattern of the graphic displayed by the display unit 280, in addition to visual display by the display unit 280, as in the case of Embodiment 2.

Embodiment 3 elicits the same effects as Embodiments 1 and 2 above. Specifically, in Embodiments 1 to 3, the size of the distance information display section 186 displayed on the display unit 180 (280) increases as the distance between the power transmission unit 220 and the power receiving unit 110 increases; and decreases as the distance between the power transmission unit 220 and the power receiving unit 110 decreases; however, the change in the display may obey a reverse pattern. Specifically, the size of the distance information display section 186 may decreases as the distance between the power transmission unit 220 and the power receiving unit 110 increases, and increases as the distance between the power transmission unit 220 and the power receiving unit 110 decreases.

In the embodiments above, the vehicle 100 (100A, 100B) is capable of receiving power from the power supply facility 200 (200A), but may also be configured so as to be capable of outputting power to the power supply facility 200 (200A).

In the embodiments above, power is transmitted, in a contactless manner, between the power transmission unit 220 and the power receiving unit 110, through resonance, mediated by an electromagnetic field, between the power transmission unit 220 and the power receiving unit 110, but the power transmission method from the power supply facility 200 to the vehicle 100 is not necessary limited to the above-described method. For instance, it is also possible to transmit power by electromagnetic induction, or using microwaves, as other contactless power transmission methods. As described above, the coupling coefficient (κ) between the power transmission unit and the power receiving unit takes ordinarily a value close to 1.0 in a case where power is transmitted by electromagnetic induction.

The charging ECU 410 corresponds to a working example of a “detection unit” of the invention, and the ECU 270 corresponds to a working example of the “detection unit” of the invention.

Thus, in the power transmission system, vehicle and power supply facility according to the embodiments of the invention, a power transmission system is a power transmission system in which power is transmitted from a power supply facility to a vehicle in a contactless manner, the power supply system having a detection unit and a display unit. The detection unit detects a distance between a power transmission unit of the power supply facility and a power receiving unit of the vehicle. The display unit displays a graphic (e.g., a diagram) in a display pattern, wherein the display pattern varies in accordance with the distance detected by the detection unit.

In the power transmission system according to the embodiment of the invention, the display unit may vary the display pattern accompanying a movement of the vehicle. In the power transmission system according to the embodiment of the invention, the display unit may vary a size of the graphic that is concentric with a pattern that denotes the power receiving unit, in accordance with a distance between the power transmission unit of the power supply facility and the power receiving unit of the vehicle.

In the power transmission system according to the embodiment of the invention, the display unit may vary the size of the graphic to be larger as the distance between the power transmission unit of the power supply facility and the power receiving unit of the vehicle increases.

In the power transmission system according to the embodiment of the invention, the display unit may vary the size of the graphic to be smaller as the distance between the power transmission unit of the power supply facility and the power receiving unit of the vehicle decreases.

In the power transmission system according to the embodiment of the invention, the display unit may vary a brightness of the graphic in accordance the distance between the power transmission unit of the power supply facility and the power receiving unit of the vehicle.

In the power transmission system according to the embodiment of the invention, the display unit may vary a flashing rate of the graphic in accordance with the distance between the power transmission unit of the power supply facility and the power receiving unit of the vehicle.

In the power transmission system according to the embodiment of the invention, the power transmission system further has a notification unit. The notification unit may generate a notification sound, a magnitude of which varies in accordance with a change in the display pattern.

In the power transmission system according to the embodiment of the invention, a difference between a natural frequency of the power transmission unit and a natural frequency of the power receiving unit may be set to be no greater than ±10% of the natural frequency of the power transmission unit or the natural frequency of the power receiving unit.

In the power transmission system according to the embodiment of the invention, a coupling coefficient between the power transmission unit and the power receiving unit may be set to be no greater than 0.1. In the power transmission system of the invention, the power receiving unit may receive power from the power transmission unit through at least one of a magnetic field that is formed between the power receiving unit and the power transmission unit and that oscillates at a specific frequency, and an electric field that is formed between the power receiving unit and the power transmission unit and that oscillates at a specific frequency.

A vehicle of the invention is a vehicle that receives power from a power supply facility in a contactless manner, the vehicle being provided with a power receiving unit, a detection unit and a display unit. The power receiving unit receives power from a power transmission unit of the power supply facility in a contact-less manner. The detection unit detects a distance between the power receiving unit and the power transmission unit. The display unit displays a graphic in a display pattern, wherein the display pattern varies in accordance with the distance detected by the detection unit.

In the vehicle according to the embodiment of the invention, the display unit may vary the display pattern accompanying a movement of the vehicle. In the vehicle according to the embodiment of the invention, the display unit may vary a size of a graphic that is concentric with a graphic that denotes the power receiving unit display in accordance with a distance between the power receiving unit and the power transmission unit.

In the vehicle according to the embodiment of the invention, the display unit may vary the size of the graphic to be larger as the distance between the power receiving unit and the power transmission unit increases.

In the vehicle according to the embodiment of the invention, the display unit may vary the size of the graphic to be smaller as the distance between the power receiving unit and the power transmission unit decreases.

In the vehicle according to the embodiment of the invention, the display unit may vary a brightness of the graphic in accordance with the distance between the power receiving unit and the power transmission unit.

In the vehicle according to the embodiment of the invention, the display unit may vary a flashing rate of the graphic in accordance with the distance between the power receiving unit and the power transmission unit.

In the vehicle according to the embodiment of the invention, the vehicle is further provided with a notification unit. The notification unit may generate a notification sound in accordance with a change in the display pattern.

In the vehicle according to the embodiment of the invention, a difference between a natural frequency of the power transmission unit and a natural frequency of the power receiving unit may be set to be no greater than ±10% of the natural frequency of the power transmission unit or the natural frequency of the power receiving unit.

In the vehicle according to the embodiment of the invention, a coupling coefficient between the power transmission unit and the power receiving unit may be set to be no greater than 0.1. In the vehicle of the invention, the power receiving unit may receive power from the power transmission unit through at least one of a magnetic field that is formed between the power receiving unit and the power transmission unit and that oscillates at a specific frequency, and an electric field that is formed between the power receiving unit and the power transmission unit and that oscillates at a specific frequency.

A power supply facility according to the embodiment of the invention is a power supply facility that supplies power to a vehicle in a contact-less manner, and that has: a power transmission unit, a detection unit and a display unit. The power transmission unit transmits power to a power receiving unit of the vehicle in a contact-less manner. The detection unit detects a distance between the power receiving unit and the power transmission unit. The display unit displays a graphic in a display pattern, wherein the display pattern varies in accordance with the distance detected by the detection unit.

In the embodiment of invention, power is transmitted from the power supply facility to a vehicle in a contact-less manner. The distance between the power transmission unit of the power supply facility and the power receiving unit of the vehicle is detected, and the display unit displays a graphic in a display pattern, wherein the display pattern varies in accordance with the detected distance. As a result, the user of the vehicle can easily know visually the distance between the power transmission unit of the power supply facility and the power receiving unit of the vehicle, by seeing the graphic that is displayed on the display unit. Therefore, the embodiment of the invention allows the user to easily know visually the distance between the power transmission unit of the power supply facility and the power receiving unit of the vehicle.

The disclosed embodiments are all exemplary in character, and must be regarded as non-limiting. The scope of the invention is defined not by the above description but by the appended claims. The invention is meant to cover all equivalents and modifications that fail within the scope of the claims.

What is claimed is:

1. A power transmission system in which power is transmitted from a power supply facility to a vehicle in a contactless manner, comprising:
a detection unit that detects a distance between a power transmission unit of the power supply facility and a power receiving unit of the vehicle; and
a display unit that displays a graphic in a display pattern that varies in accordance the distance detected by the detection unit.

2. The power transmission system according to claim 1, wherein
the display unit varies the display pattern accompanying a movement of the vehicle.

3. The power transmission system according to claim 1, wherein
the display unit varies a size of the graphic that is concentric with a graphic that denotes the power receiving unit, in accordance with the distance detected by the detection unit.

4. The power transmission system according to claim 3, wherein
the display unit varies the size of the graphic to be larger as the distance increases.

5. The power transmission system according to claim 3, wherein
the display unit varies the size of the graphic to be smaller as the distance decreases.

6. The power transmission system according to claim 1, wherein
the display unit varies a brightness of the graphic in accordance with the distance detected by the detection unit.

7. The power transmission system according to claim 1, wherein
the display unit varies a flashing rate of the graphic in accordance with the distance detected by the detection unit.

8. The power transmission system according to claim 1, further comprising:
a notification unit that generates a notification sound, a magnitude of which varies in accordance with the distance detected by the detection unit.

9. The power transmission system according to claim 1, wherein
a difference between a natural frequency of the power transmission unit and a natural frequency of the power receiving unit is no greater than ±10% of the natural frequency of the power transmission unit or the natural frequency of the power receiving unit.

10. The power transmission system according to claim 1, wherein
a coupling coefficient between the power transmission unit and the power receiving unit is no greater than 0.1.

11. The power transmission system according to claim 1, wherein
the power receiving unit receives power from the power transmission unit through at least one of (i) a magnetic field that is formed between the power receiving unit and the power transmission unit and that oscillates at a specific frequency, and (ii) an electric field that is formed between the power receiving unit and the power transmission unit and that oscillates at a specific frequency.

12. A vehicle that receives power from a power supply facility in a contactless manner, comprising:
a power receiving unit that receives power from a power transmission unit of the power supply facility in a contact-less manner;
a detection unit that detects a distance between the power receiving unit and the power transmission unit; and
a display unit that displays a graphic in a display pattern which varies in accordance the distance detected by the detection unit.

13. The vehicle according to claim 12, wherein
the display unit varies the display pattern accompanying a movement of the vehicle.

14. The vehicle according to claim 12, wherein
the display unit varies a size of the graphic that is concentric with a graphic that denotes the power receiving unit, in accordance with the distance detected by the detection unit.

15. The vehicle according to claim 14, wherein
the display unit varies the size of the graphic to be larger as the distance increases.

16. The vehicle according to claim 14, wherein
the display unit varies the size of the graphic to be smaller as the distance decreases.

17. The vehicle according to claim 12, wherein
the display unit varies a brightness of the graphic in accordance with the distance detected by the detection unit.

18. The vehicle according to claim 12, wherein
the display unit varies a flashing rate of the graphic in accordance with the distance detected by the detection unit.

19. The vehicle according to claim 12, further comprising:
a notification unit that generates a notification sound, wherein a magnitude of the notification sound varies in accordance with the distance detected by the detection unit.

20. The vehicle according to claim 12, wherein
a difference between a natural frequency of the power transmission unit and a natural frequency of the power receiving unit is no greater than ±10% of the natural frequency of the power transmission unit or the natural frequency of the power receiving unit.

21. The vehicle according to claim 12, wherein
a coupling coefficient between the power transmission unit and the power receiving unit is no greater than 0.1.

22. The vehicle according to claim 12, wherein
the power receiving unit receives power from the power transmission unit through at least one of a magnetic field that is formed between the power receiving unit and the power transmission unit and that oscillates at a specific frequency, and an electric field that is formed between the power receiving unit and the power transmission unit and that oscillates at a specific frequency.

23. A power supply facility that supplies power to a vehicle in a contact-less manner, comprising:
a power transmission unit that transmits power to a power receiving unit of the vehicle in a contact-less manner;
a detection unit that detects a distance between the power transmission unit and the power receiving unit; and
a display unit that displays a graphic in a display pattern which varies in accordance with the distance detected by the detection unit.
